(19) United States
(12) Patent Application Publication
(10) Pub. No.: US 2003/0032393 A1
(43) Pub. Date: Feb. 13, 2003

(54) Personal computer phone patch

(76) Inventors: Johnny Lee Kennedy, Florissant, MO (US); Robert C. Boaz, St. Charles, MO (US); Kenneth R. Boaz, Clear Water, FL (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/134,321

(22) Filed: Apr. 29, 2002

Related U.S. Application Data
(60) Provisional application No. 60/286,900, filed on Apr. 27, 2001.

(51) Int. Cl. H04B 1/40; H04M 11/00

(52) U.S. Cl. 455/74.1; 379/93.09

(57) ABSTRACT

The present disclosure provides a device for attaching a personal computer having left and right speaker outputs and a microphone input to a telephone for use in a PSTN telephone system including a personal computer interface control stage that is connected the telephone for sending and receiving audio signals between the telephone and personal computer interface control stage, is connected to the personal computer microphone input to transmit audio received from a local conversant using the telephone to the personal computer, is connected to the left and right speaker outputs to receive an audio signal of a remote conversant through the personal computer, is connected to an audio mixer to transmit the left and right speaker inputs received from the personal computer to an audio mixer wherein the left and right audio inputs are mixed to a single output, is connected to an echo ejection circuit to transmit and receive a duplex audio signal receive from the telephone, is connected to a level adjustment stage to receive audio for transmission to the microphone input and wherein the echo rejection circuit is attached to the audio mixer to receive the mixed signal and the level adjustment stage to transmit the echo rejected signal and wherein the device requires no external power source.

### CROSS-REFERENCE TO RELATED APPLICATIONS

The present application claims priority to U.S. Provisional Patent Application Serial No. 60/286,900, the contents of which are hereby incorporated by reference.

### BACKGROUND OF THE INVENTION

In recent times, many long distance Internet telephone companies (LDITC) have established an on-line presence offering low cost, or no cost, voice communications. Known as Internet telephony, subscribers may talk from their PC, to another subscribers PC, or to a standard telephone (PC not required by the person receiving the call). The standard telephone is patched to the Internet with LDITC equipment.

While two-way conversation is possible, when the LDITC user is speaking through his multimedia microphone, and listening through his multimedia speakers, care must be taken to prevent echo. It is necessary to keep the speaker volume low enough to prevent the microphone from “hearing” the speaker audio. When the volume is too high, speaker audio detected by the microphone is transmitted back to its source. This condition results in a distracting echo on the other end of “line”. If both callers are communicating via PC-to-PC, this echo may be heard by both parties. This is an unacceptable condition and will likely prevent many people from using the Internet as a medium to carry their long distant calls.

Another inconvenience is a requirement for the user to sit in front of his or her PC during conversation on the Internet. This is because some products such as a head-phone/microphone combination, or a telephone like handset plug into the PC's sound card, with a long wire, in place of the speaker and microphone. Other products designed to connect the users PC to a telephone require installation of hardware and software within the PC.

Several products have been developed to connect a telephone to the multimedia PC. Three such products are the “PhoneBridge”, “The Internet Phone Jack” and the “Internet Phone Wizard”. Each of these products, except the “PhoneBridge”, connects to the PC by way of data-buss. The PhoneBridge connects to the PC's sound card much like the PCPP. However, the PCPP does not require external power (batteries, power-packs, 115 VAC wall outlets, etc.) to operate where as the “PhoneBridge” does. Also, the PCPP provides access to the Public Switched Telephone Network (PSTN), where as the “PhoneBridge” does not. The “PhoneBridge” requires a corded 12 VDC power pack providing an external source of electricity to operate relays and amplifiers, and does not provide access to the PSTN. The “The Internet Phone Jack” is part of an internal sound card, connects to the internal PC buss (data buss inside PC) and requires the user to open his PC and install a circuit card assembly. The “Internet Phone Wizard” connects to the PC using the USB (Universal Serial Buss) or the internal PCI buss. Again, the user is required to open his PC and install a circuit card assembly if the PCI version is used. Each product, except for the “PhoneBridge”, requires the installation of software, and each of these products, except for the “PhoneBridge”, are not easily moved from one computer to another. Many computer users would find it necessary to have a skilled technician install any product that requires opening their PC.

### BRIEF SUMMARY OF THE OBJECTS OF THE INVENTION

Among the several objects and advantages of the present invention are:

1) Works with cordless phones allowing user mobility not previously possible (i.e., the user is not forced to sit in front of their computer while talking across the Internet).

2) Does not require external power from batteries, power-packs, 115 VAC wall outlets, etc., thus improving user installation convenience and minimizing unnecessary AC or DC power cords, power-packs, etc.

3) Allows privacy while talking on the phone.

4) Solves severe echo problem common with Internet phone connections.

5) Full duplex operation (note: user must have full duplex sound-card and proper software settings to engage in full duplex operation)

6) Provides access to unused phone line.

7) Allows easy switching between the Internet phone call and the cordless telephone line.

8) May be plugged into any sound card.

9) Does not require any expertise to install (i.e., opening the computer is not necessary).

10) Does not require any installation software.

11) Low cost, and quickly pays for itself in long distant savings.

12) Easy to use.

13) Small and portable.

Briefly stated, the Personal Computer Phone Patch (PCPP) makes possible the use of a cordless telephone when making long distance phone calls across the Internet. The PCPP is an analog peripheral device designed to interface a cordless telephone with the sound card of the typical multimedia PC. The PCPP may be built as a stand-alone unit or as an integral part of a cordless telephone.

The foregoing and other objects, features and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

FIG. 1 is a block diagram of the present invention according to a first embodiment;

FIG. 2 is a block diagram of the present invention according to a second embodiment; and

FIG. 3 is a block diagram of the present invention according to a third embodiment.

### DETAILED DESCRIPTION OF THE PREFERRED EMBODIMENTS

The Personal Computer Phone Patch (PCPP) makes possible the use of a cordless telephone when making long distance phone calls across the Internet. The PCPP provides full duplex (simultaneous bi-directional), echo canceling communication, with comparable quality to the standard telephone system. Using a cordless telephone in place of the multimedia speakers and microphone used with most PC's (Personal Computers), provides a more comfortable and familiar way to experience PC based long distance Internet phone calls. Also, and perhaps most important, use of the PCPP allows the type of privacy and mobility most people are used to when talking on the phone. This privacy and mobility is because, the individual on the other end of the line will not be heard through the PC speakers; they will be heard by the user only, through the users cordless phone.

As an added convenience, the user may easily switch back-and-forth between the Internet connection and an unused phone line. The unused phone line may be a second phone line or the user's primary phone line if the user's PC is connected to the Internet with a cable or DSL (Digital Subscriber Line) modem. Users of slow speed Internet connections (56.6 kbps modems, as opposed to DSL or cable modems) may experience small, but noticeable, delays in conversation depending upon the circumstances of their connection.

### Basic Phone Features

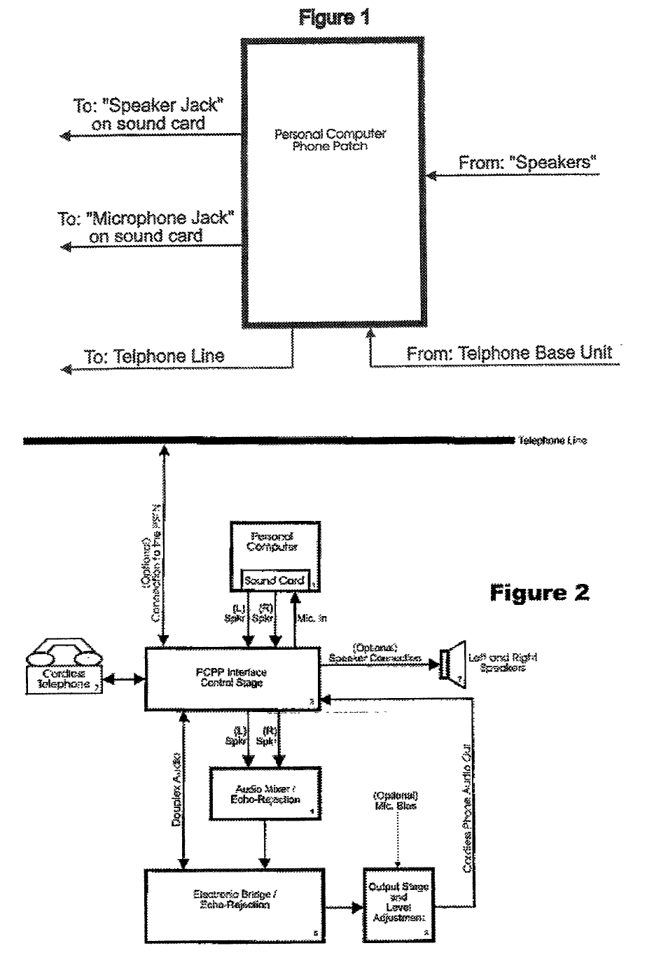

Referring to FIG. 1, the PCPP may be “plugged-in” to the speaker and microphone jacks on the PC's sound card. The PC's speakers may then be “plugged-in” to the PCPP. Switches have been provided and perform the following functions: 1) allow the user to switch between the Public Switched Telephone Network (PSTN) and the PC sound card, and 2) allow the user to switch the sound-card output audio between the PC's speakers and the cordless telephone.

The PCPP is equipped with a telephone cord using a modular phone plug for connection to the PSTN. The PCPP was designed to operate without external power. Therefore, it is not necessary to “plug-in” another 12 VDC power pack, for example, into what is many times an already over crowded wall outlet.

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Detailed block diagram of Basic Phone Features

Referring to FIG. 2, audio and phone line interfaces are controlled by block 3, the “PCPP Interface Control Stage”. This stage allows users selection between the PSTN (represents the Telephone Line in FIG. 1) and the PC sound card (block 1). This stage also allows soundcard output audio selection between the PC's speakers (block 7) and the cordless telephone (block 2).

Audio from the PC's speakers is routed to block 4 “Audio Mixer/Echo-Rejection”. This block performs as its title implies. Since Internet voice communication is monaural, and voice audio may be present at either, or both, sound-card speaker output, the mixer combines both left and right sound-card speaker output into one signal. While echo-rejection is performed primarily in block 5, “Electronic Bridge/Echo-Rejection”, the initial echo reduction occurs when block 4 works in conjunction with block 5.

The cordless telephone (block 2) interface to the PSTN is “two-wire”, full duplex. This means both transmit and receive signals can travel on the same pair of wires at the same time. The echo problem becomes apparent after considering the following: The users speech must pass through a pair of wires connecting the users telephone to the PCPP while on its way to the microphone input of the PC sound-card. The received audio from the person called must pass through the same pair of wires on its way to the users telephone. Simply stated, the problem is this: allow only user audio to reach the microphone input and not audio from the person called, even though user audio and person called audio share the same pair of wires.

The audio output from block 4 is split into two separate, pseudo-isolated, in-phase paths. These two paths then feed separate branches of a bridge within block 5. One branch within block 5 interfaces the cordless telephone, while the other branch electrically approximates the first branch. An optional control for the other branch would be an adjustment that allows even further reduction of the approximation, thus providing greater rejection of echo if necessary. Note, practical application has demonstrated that an electrical approximation of the first branch is adequate in most cases. Balance of the bridge provides the second level of echo rejection, and is important to prevent distracting levels of echo from reaching the microphone input (Mic. In) on the PC sound card while the called party speaking.

Block 6, “Output Stage and Level Adjustment”, provides isolated, and mostly echo free, audio for input into the PC sound card. This stage allows reduction of the audio output to the level where the remaining audible echo is reduced below detectable limits. Block 6 provides the last step of echo reduction while passing reasonable amplitudes from the cordless phone. Optional implementations of Block 6 would be to use the microphone bias from the PC sound card to power a single stage amplifier if higher drive levels were desired. Using the microphone bias from PC sound-card would be in keeping with the original design goal to not require external power from batteries, power-packs, and/or 115 VAC wall outlets, etc.

Other possible embodiments of this invention are as follows but not limited to

1. A stand-alone PCPP that connects between the personal computer sound card and the users cordless telephone.

2. A PCPP built into, as an integral part of, a cordless telephone.

3. A PCPP that switches between the PSTN and the personal computer sound card when a function key on the standard keyboard is pressed. Power to allow this switching operation would be provided by the computer, thus eliminating the need for external power such as batteries, power packs, and/or 115 V AC wall outlets, etc. The function key may also be used to “launch” the users favorite Long Distance Internet Telephone Service Provider's software.

4. Installation into the personal computer with the attributes of embodiment 3 above.

5. Installation into stand-alone multimedia speakers similar to those currently in use by most personal computers today.

6. Installation into multimedia keyboard (i.e., keyboards with built-in speakers)

7. The inclusion of a microphone input jack so the user will not loose the utility of the standalone microphone.

8. Installation into a system designed to allow remote access and Browser/Long Distance Internet Telephone software control from any cordless phone using the touch-tone keypad.

9. Installation into a stand-alone speakerphone used for PSTN access and Internet telephony.

10. Installation into a FAX terminal at such time as fax session handling protocols have been established for Internet use.

11. Incorporation into television sets or cable boxes.

12. Incorporated with other circuit means to allow the following:

a. A caller notification tone when an unused telephone line is receiving a ring signal from a remote caller.

b. A switching means to allow the user to “switch over” to the unused telephone line (referenced in a. above) and back, at will.

c. Additional audio over the Internet, besides voice, such as a “ticking sound” to serve the purpose of holding remote voice operated switches (VOX, used in equipment to transform voice-over-internet to standard analog PSTN and vice-versa) in the open state, thus mitigating threshold and attack-time issues associated with the typical VOX.

d. Additional audio over the Internet, besides voice, such as a “ticking sound” to serve the purpose of maintaining connection with one's Internet Service Provider while speaking to the caller on the alternate telephone line via reference means provided in a. and b. above.

### Advanced Phone Features

Further improvements to the above design may be implemented whereby the phone further implements the ability to

1. Make Calls Across the Internet by Dialing Through the Phone rather than the PC. Provide the user with the convenience of placing internet phone calls through a selected telephone “Touch-Tone” keypad. Accomplish this by: 1) interfacing the cordless telephone base unit to a standard keyboard, or 2) by designing a stand alone “box” that connects between the cordless telephone base unit, the keyboard, and the computer.

2. Phone Rings With Incoming Internet Calls. Provide the user with an audible ring signal from the telephone handset to let the user know a call is arriving from across the internet.

3. “Call-Waiting” Type Tone. Provide the user with a type of “call-waiting” notification by providing a tone in the user's handset when a call arrives across the standard telephone line (PSTN: Public Switched Telephone Network).

4. Switch From Internet Calls to Standard Calls and Back

Allow the user to switch from the internet phone call to the PSTN (and back if desired) by pressing one or two “Touch-Tone” keys.

To implement the above capability, there must be at minimum a macro application running on the user's computer and a continuous connection to the internet either via second phone line, cable access, etc.

In order to implement the ability to dial from the phone to cause software resident upon the computer to react to the phone and transmit a corresponding phone number through call-placing software resident upon the computer, the PCPP may be improved by adding the following additional capabilities:

1. A method to make appropriate keyboard and mouse entries into internet phone dialing software resident on the computer, such as the “Net2Phone ComCenter”, circumventing direct user contact with the computer keyboard. This may be accomplished in two ways:

a. Method 1: Build the PCPP and a “Touch-Tone” decoder along with a keyboard switch interface into a standard keyboard. Install a modular phone jack onto the standard keyboard. In this method, the keyboard converts DTMF tones into keyboard sequences for communicating with the internet phone dialing software.

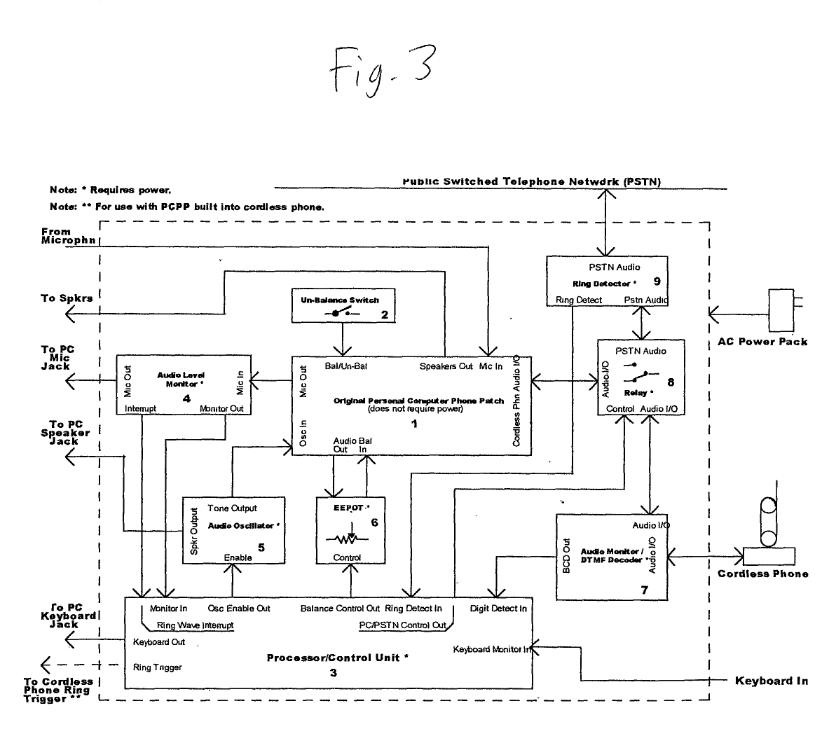

b. Method 2: Referring to FIG. 3, build the PCPP, and a “Touch-Tone” decoder along with an appropriate microcontroller keyboard interface circuit into a stand-alone unit. This stand-alone unit may be designed to serve as a keyboard signal generator providing keyboard scan codes to correspond with “Touch-Tone” keys on the cordless phone, and a traffic coordinator between the keyboard originated signals and the cordless telephone “Touch-Tone” originated signals. Next, install a modular phone jack and a keyboard jack onto the stand-alone unit along with a corded keyboard plug, and connect the keyboard and cordless phone to the computer through the stand-alone unit.

In order to generate an audible ring signal at the cordless telephone handset in response to a call arriving from the internet and referring to FIG. 3, a ring detection circuit for the PCPP (to detect simulated telephone ring signals from the computers speakers) is implemented that directly interfaces this circuit to the internal electronics of the cordless telephone base unit.

In order to notify the user of a single line cordless telephone when a call has arrived on the standard telephone line (i.e. the Public Switched Telephone Network) while the user is talking across the internet, the present invention implements a ring detector for the PSTN that will couple a “call-waiting” type tone into the cordless telephone base unit via the PCPP. The call-waiting type tone must be generated within the PCPP.

In order to allow the user of a single line cordless telephone to switch back and forth between the internet telephone call and the PSTN without compromising the call waiting service available from many phone companies.

More specifically, the above improvements are implemented, with reference to FIG. 3, in the following manner. FIG. 3 represents the Personal Computer Phone Patch (within the dashed box) showing all added improvements. An “AC Power Pack” is shown supplying the dashed box with power for each block (marked by “*”) except block 1, the original Personal Computer Phone Patch (PCPP), and block 2, a simple mechanical switch. Since the Improved PCPP may be a stand-alone unit or built into a cordless telephone base, the features below will indicate when referring to the built-in version.

1. Works with any/most cordless phones

i) Adjustments are automatic, but are initiated by the user by pressing one or two Touch Tone keys on the user's phone.

ii) Allows user mobility not previously possible (i.e., the user is not forced to sit in front of their computer while talking across the Internet).

2. Allows privacy while talking on the phone.

3. Solves severe echo problem common with Internet phone connections,

4. Full duplex operation (note: user must have full duplex sound-card and proper software settings to engage in full duplex operation)

5. Provides incoming call notification to the user's handset when calls are arriving across the PSTN (Public Switched Telephone Network) and the user is talking across the internet.

6. Provides incoming call notification when calls are arriving across the internet and the user is talking across the PSTN.

i) This applies to cordless phones with a built-in PCPP.

ii) Accomplished by providing a ring trigger from the PCPP that interacts with the cordless phone ring circuit.

7. Allows easy switching (one button Touch Tone control or “Flash” control) between the Internet phone call and the PSTN phone call.

8. May be plugged into any sound card.

9. Does not require any expertise to install (i.e., opening the computer is not necessary).

10. Requires installation of Macro software to generically control the computer from a remote location via the cordless telephone Touch Tone keypad.

11. Allows the user to transmit prerecorded audio files (audio files on the user's computer) across the internet to another person or answering machine.

### Description of Block 1

As stated above, block 1 does not require power (as described with respect to basic phone features). If the AC Power Pack (shown in FIG. 3) were left unplugged, block 1 would continue to operate, but not at optimal echo rejection settings. For continued operation without power, the relaxed or not enabled relay of block 8 must be configured to connect the Audio I/O from block 8 to block 1.

Block 1 when properly adjusted by block 3 via block 6 will adequately reject echo for high quality bi-directional internet conversation.

### Description of Block 2

Block 2 is nothing more than a simple mechanical switch used to disrupt the balance necessary for echo rejection. By un-balancing block 1, audio appearing at the speaker output on the computer soundcard will also appear on the microphone input to the computer sound card, but at a reduced level.

By unbalancing block 1, the user will be able to play prerecorded audio files on his computer across the internet. This capability may be operating system dependant; however, operating systems such as Windows 2000 will support this function.

### Description of Block 3

Block 3 is the Processor/Control Unit and is responsible for monitoring or controlling all functions and blocks except block 2. Block 3 has the following capability:

1) Monitors block 7 to determine

a. When a Touch Tone key has been pressed on the cordless telephone handset.

b. What Touch Tone key has been pressed on the cordless telephone handset.

2) Performs a user initiated automated balance routine to adjust for maximum echo rejection.

a. When command by the operator, by pressing one or two Touch Tone keys on the cordless telephone handset, block 3 will enable block 5, thereby injecting a tone of suitable frequency into block 1 for the purpose of monitoring block 4 to determine if block 1 is in a state of balance with the users cordless telephone connected through blocks 7 and 8. If a balance state does not exist, block 3 will send control information to block 6 until the monitor signal from block 4 indicates block 1 has entered a balanced state. During this process, the user will be able to hear the tone generated by block 5 in the cordless telephone handset.

b. When block 3 determines block 1 is in a state of balance, block 3 will end the tone generated by block 5, and stop controlling block 6. Block 3 will however, continue to monitor block 4 for a prolonged state of imbalance (see 4 below). The user will know when the tone from block 5 stops, because the tone in the cordless telephone handset (the same tone) will also stop. This signifies the end of the user initiated auto balance process.

c. This user initiated automated balance process will allow the user to attach nearly any cordless phone to the invention depicted in FIG. 2 (unless of course, the invention is built into a cordless telephone).

3) Block 3 will monitor block 9 while the user is communicating across the internet to determine when a ring signal is present on the PSTN and perform the following routine:

a. When block 9 notifies block 3 of an incoming call across the PSTN, block 3 will enable block 5, to generate a tone (the same frequency as used for the user initiated auto balance routine above). This tone will be of short duration and will be heard by the user in the cordless telephone handset. The purpose is to notify the user of an incoming call on the PSTN.

b. Having been notified of an incoming call on the PSTN, the user may press a touch-tone key (or keys), monitored by block 3 through block 7. The purpose of which will instruct block 3 to send a control command to block 8 causing the cordless phone connection to switch to the PSTN, allowing the user to accept the incoming call.

c. After conversation across the PSTN has finished, the user may press a touch-tone key (or keys), monitored by block 3 through block 7. The purpose of which will instruct block 3 to send a control command to block 8 causing the cordless phone to reconnect with the computer soundcard, via blocks 7 and 8, thereby allowing the user to continue with internet conversation.

d. The user may switch back and forth between the PSTN and the internet at will and at any time except during the user initiated automated balance process.

4) Block 3 will generate a ring trigger if block 4 indicates and incoming internet call by issuing a Ring Wave Interrupt. An incoming internet call that causes the sound card speaker output to playa “ring” wav file (used to simulate a ringing telephone) will cause a prolonged and excessive audio level to be generated in block 4 resulting from an “on-hook” (hung-up) state of the cordless telephone. This is because block 1 is grossly unbalanced when the cordless phone is on-the-hook. After determining the presence of a prolonged imbalance, block 4 will issue a Ring Wave Interrupt to block 3.

The ring trigger, if used, will interact with the ringer electronics of a cordless telephone in which the PCPP has been built in. This constitutes a second embodiment of the PCPP (the first being a stand alone unit).

5) The most important function of block 5 is to transmit keyboard scan codes to the computer corresponding to keypad depressions on the cordless phone. When the cordless phone is connected through the PCPP to the computer, and the user presses any keypad (Touch-Tone) button, Block 3 will retrieve the appropriate scan code from memory and send it to the computer via the computer keyboard jack. The computer, loaded with a macro program designed to “watch” for specific scan codes will implement the necessary control instructions to the user's long distance internet software. Note, the user's long distance internet software is part of the long distance internet service provided by a 3rd party.

When the cordless phone is connected through the PCPP to the computer and the user is not pressing any keypad (Touch-Tone) buttons, or when the cordless phone is connected to the PSTN via blocks 7, 8, and 9, block 3 will allow the normal keyboard generated scan codes to pass unimpeded.

### Description of Block 4

Block 4 performs the following functions:

1) Monitors the audio output from block 1, and provide a signal (Monitor Out), which may be either analog or discrete; to block 3 for use during the user initiated automated balance process.

2) Monitors block 1 for a prolonged imbalance when an incoming internet call causes the soundcard speaker output to playa “ring” wav file (used to simulate a ringing telephone). After determining the presence of a prolonged imbalance, block 4 will issue a Ring Wave Interrupt to block 3.

3) Passes the unimpeded microphone audio form block 1 to the computer soundcard microphone input.

### Description of Block 5

Block 5 generates an audio tone when enabled by block 3:

1) For use during the user initiated automated balance process.

2) For use during the PSTN incoming call notification process.

Block 5 passes unimpeded audio from the computer soundcard speaker output to block 1.

### Description of Block 6

Block 6 is composed of an electronic programmable potentiometer. This potentiometer is controlled by block 3 and used to establish maximum echo rejection within block 1. To establish maximum echo rejection, block 3 must run the user initiated automated balance routine described above (Block 3, par. 2).

### Description of Block 7

Block 7 provides high impedance monitoring (designed not to electrically load the phone line) of the cordless phone line for decoding DTMF touch-tone signals from the cordless phone. These decoded signals are provided to block 3 in BCD (binary coded decimal) format.

### Description of Block 8

Block 8 contains a DPDT (double pole double throw) relay and is directly controlled by block 3. This relay is used to switch the cordless telephone connection between the PSTN and the internet conversation, or vice-versa. The DPDT relay will completely disconnect the cordless telephone from the PSTN during internet conversation and will reconnect the cordless phone to the PSTN during non-internet conversations. The switch state of the DPDT relay may be changed at will by the user as described above (Block 3).

### Description of Block 9

Block 9 provides high impedance monitoring (designed not to electrically load the phone line) of the PSTN. The purpose is to notify block 3 when a PSTN ring signal has been detected. This monitoring process is part of the PSTN call alert function described above (Block 3).

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

We claim:

1. An analog peripheral device designed to interface a cordless telephone with the sound card of the typical multimedia PC and provides the following:
A. Full duplex (simultaneous bi-directional) operation,
B. Echo canceling communication,
C. Comparable quality to the standard telephone system,
D. For use with a cordless phone.
E. Built as a stand-alone unit (fits between a cordless telephone and the personal computer sound-card), or
F. Built into the base of a cordless telephone (i.e., an integral part of a cordless telephone).
G. User adjustment of microphone output level.

2. Operates without the use of external power such as batteries, power packs, and/or 115 VAC wall outlets, etc.

3. Works with any electronic phone capable of generating its' own audio output independent of the Local Subscriber Loop Current from the telephone company.
